(19) United States
(12) Patent Application Publication
(10) Pub. No.: US 2008/0149429 A1
(43) Pub. Date: Jun. 26, 2008

(54) DRIVE SYSTEM FOR ELEVATOR CAR ROOF

(76) Inventors: Mario Fernandes, Mulhouse (FR); Emmanuel Kolb, Reiningue (FR); Denis Sittler, Illzach (FR); Denis Wagner, Ensisheim (FR)

Correspondence Address: FRASER CLEMENS MARTIN & MILLER LLC, 28366 KENSINGTON LANE, PERRYSBURG, OH, 43551, US

(21) Appl. No.: 12/039,903

(22) Filed: Feb. 29, 2008

Related U.S. Application Data
(62) Division of application No. 11/467,943, filed on Aug. 29, 2006.

(30) Foreign Application Priority Data
Aug. 30, 2005 (EP) 05107905.1

(51) Int. Cl. B66B 9/02

(52) U.S. Cl. 187/250

(57) ABSTRACT

A method for carrying out maintenance and inspection operations at an elevator installation with an elevator car having a lowerable car roof that serves as maintenance platform, comprises at least the following steps: positioning the elevator car at a selected floor and opening the elevator doors; lowering the car roof into the elevator car to work level; climbing of the maintenance person with the help of climbing equipment from the selected floor through the elevator doors onto the lowered car roof, closing the elevator doors; and moving the elevator car to maintenance positions.

### BACKGROUND OF THE INVENTION

The present invention relates to a method for carrying out maintenance and inspection operations at an elevator installation.

It is known that maintenance operations at elevator components arranged in the elevator shaft are undertaken by a maintenance person standing on the car roof of the elevator car. The elevator car is for this purpose movable in the entire elevator shaft by means of an inspection control. During this process it is absolutely necessary to ensure, through additional technical measures, a safety spacing between the car roof of the elevator car and the shaft roof or between the car roof and elevator components installed in the region of the shaft roof, so as to avoid the possibility of the maintenance person being trapped.

JP 09263372 discloses a solution which ensures that such a safety spacing is kept. It is proposed therein to so design an elevator car that its car roof is lowerable into the passenger compartment so that it forms a maintenance platform from which the maintenance person carries out inspection or repair operations at elevator components fixed in the elevator shaft. Through lowering of the car roof it is achieved that the said safety spacing is guaranteed without special safety devices, such as, for example, abutment buffers pivotable into the car travel path or an additional switching device, which forms a downwardly displaced upper electrical path limitation, being required.

The maintenance method, in which a lowerable car roof serves as maintenance platform, disclosed in JP 09263372 has certain disadvantages, which are briefly described in the following:

In order that a maintenance person can get onto the car roof of the elevator car the maintenance person standing at a floor must ensure, by a relatively inconvenient process, that the car stops below its normal floor position so that the maintenance person can go from the floor to the roof of the elevator car. This usually takes place in that the maintenance person, when the elevator car moves past, manually unlocks the shaft door of the elevator installation at the correct point in time so that the elevator car is stopped. Since the position of the moving elevator car is usually only recognizable by a door gap and the elevator car moves past at considerable speed this method is time-consuming and requires considerable skill on the part of the maintenance person to unlock the shaft door at the correct point in time. Moreover, the unlocking and subsequent opening of the shaft door are connected with the risk of falling into the elevator shaft if the elevator car has not stopped at the desired position.

The maintenance person must, from the car roof and with the help of a manually operated cable drum, lower the car roof to the work level thereof and after conclusion of the maintenance operation raise it back to normal level, wherein the roof moving device is added to the weight of the car roof, with the weight of the maintenance person.

### SUMMARY OF THE INVENTION

The present invention has an object of proposing a method for carrying out maintenance and inspection operations at an elevator installation of the kind stated in the introduction, which does not have the stated disadvantages of the equipment cited as state of the art. In particular, there shall thus be created a method by which the maintenance person gets onto the car roof without that person being obliged to stop, with much expenditure of time and skill, the elevator car at a height not corresponding with a normal floor level, without the maintenance person having to accept the risk of a fall and without the maintenance person having to move the car roof with the additional loading by the maintenance person downwardly and, especially, upwardly.

The invention is accordingly based on the concept of eliminating the aforesaid problems by a maintenance method:
in which accessing of the car roof takes place while the elevator car is disposed at a normal floor level to which it was preferably controlled by way of a normal floor call via the elevator control, wherein the elevator doors are automatically opened; and
in which the car roof is moved upwardly and downwardly in the elevator car before the maintenance person has gone onto this or after the maintenance person has again left the car roof.

According to a particularly preferred refinement of the maintenance method according to the present invention the elevator car is automatically positioned at the selected floor by the elevator control on the basis of a floor call, after which the car door as well as the shaft door are automatically opened.

In an advantageous manner a drive means by which the lowerable car roof is lowered and raised is driven with the help of a drive device actuable manually or by electric motor.

A refinement of the method is that the drive device is actuated by the maintenance person with the help of a hand crank or an electrically operated mobile torque motor which is space-saving and economic.

Performance of the method in a manner which is particularly convenient to operate is achieved in that the drive device is arranged in the region of a door transom of the car door and is manually actuated by the maintenance person standing in the region of the door openings of the car door and the shaft door and on the respectively associated floor.

A notable freedom of movement and low risk of accident for the maintenance person is offered by a refinement of the method according to the present invention in which the drive means by which the lowerable car roof is lowered and raised comprises several Bowden pulls, wherein the force required for raising and holding the car roof is transmitted to the car roof by pull means of the Bowden pulls from the drive device by way of support points at the elevator car.

An improvement in operating friendliness thanks to reduction in the expenditure of force to be exited by the maintenance person is achieved by refinement of the method in which at least partial compensation is provided for the weight force of the lowerable car roof by means of a relief device present in the form of a spring-driven cable drum.

According to a particularly advantageous refinement of the present invention a climbing ladder installed on the lowerable car roof is used as climbing equipment.

A refinement of the method according to the present invention has proved particularly convenient and operationally reliable in which the climbing ladder is pivotably mounted at one end thereof on a horizontal axis, which is arranged in the region of the front edge of the car roof at the car door side, of a joint and prior to climbing of the maintenance person onto the lowered car roof is pivoted by this maintenance person out of its horizontal position on the car roof through an angle of approximately 270° into an almost vertical climbing position in the region of the car door.

According to a variant of the method which saves space and is usable in all configurations of the elevator car the climbing ladder comprises a plurality of telescopically extensible segments, wherein the climbing ladder in pushed-together state is pivoted about the horizontal axis below a door transom of the car door into its vertical climbing position and is subsequently pulled out to full length.

According to a particularly preferred refinement of the method the foot of the pivoted-down climbing ladder is supported in the region of the car door threshold on a floor of the elevator car, wherein the climbing ladder is so positioned that the car door and the shaft door can be closed before the car elevator is moved to the maintenance position.

### DESCRIPTION OF THE DRAWINGS

The above, as well as other, advantages of the present invention will become readily apparent to those skilled in the art from the following detailed description of a preferred embodiment when considered in the light of the accompanying drawings in which:

FIG. 1 is a schematic perspective view of an elevator car with lowerable car roof, which is suitable for use in the method according to the present invention;

FIG. 2 is a schematic view a first alternate embodiment of a drive device for lowering and raising the car roof,

FIG. 3 is a cross-sectional view taken along the line III-III in FIG. 2;

FIG. 4 is a schematic view of a second alternate embodiment of a drive device for lowering and raising the car roof;

FIG. 5 is a cross-sectional view taken along the line V-V in FIG. 4;

FIG. 6 is an enlarged detail view of the drive device for lowering and raising the car roof shown in FIG. 2 with safety devices for preventing unauthorized actuation and unintended lowering of the car roof according to the present invention;

FIG. 7 is a cross-sectional view taken along the line VII-VII in FIG. 6;

FIG. 8 is a schematic view of locking means against dropping for the prevention of unintended dropping down of the car roof according to the present invention;

FIG. 9 is a schematic view of an elevator car with lowered car roof and pivoted-down, telescopically extensible climbing ladder according to the present invention;

FIG. 10 is an enlarged detail, as seen from the side of the elevator car, of the pivoting and extending function of the climbing ladder shown in FIG. 9;

FIG. 11 is a schematic view, as seen from the shaft door onto the elevator car, of the climbing ladder shown in FIG. 10; and

FIG. 12 is a cross-sectional view through the climbing ladder with a ladder post locking device for locking the telescopically extensible rectangular tubes (sections) of the climbing ladder.

### DESCRIPTION OF THE PREFERRED EMBODIMENT

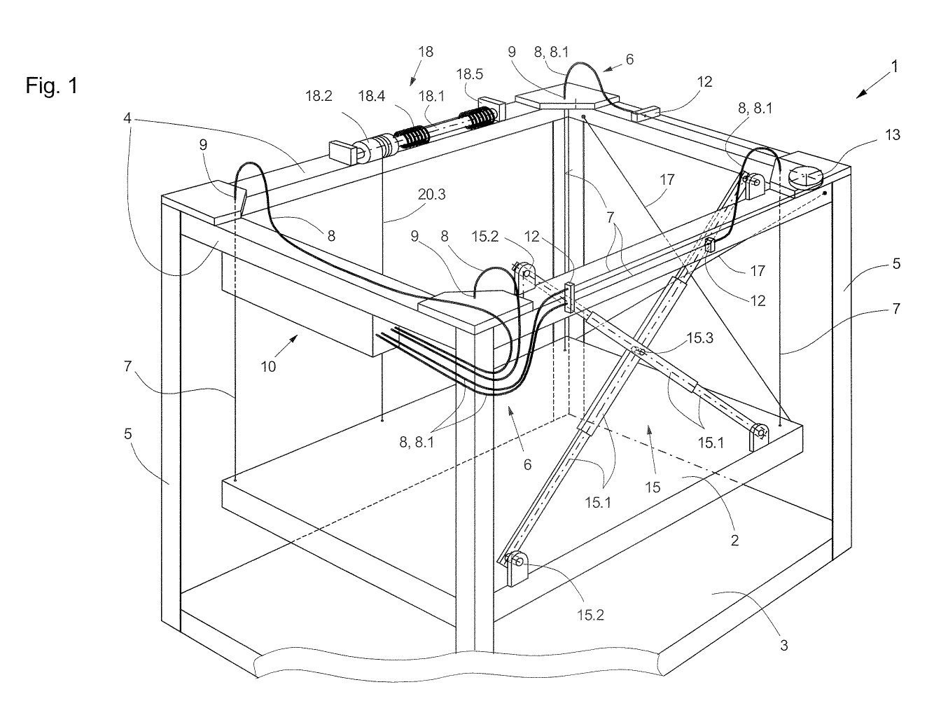

FIG. 1 schematically shows an elevator car 1 according to the present invention with a lowerable car roof 2, which in the illustrated lowered position can serve as a maintenance platform for maintenance or repair of elevator components arranged in the elevator shaft. The elevator car 1 comprises, as principal components, a car floor 3, a roof frame 4 which is connected with the car floor 3 by way of vertical posts 5, and the car roof 2, which is suspended at a pull means 7 by four Bowden pulls 6 and lowerable with the help of these Bowden pulls 6 and which in normal operation is fixed within or below the roof frame 4. Car walls and also car doors are not illustrated in FIG. 1 for reasons of clarity.

The Bowden pulls 6, of which each comprises a flexible casing tube 8, which is continuous or formed by several sections, with the pull means 7 guided therein, connect the lowerable car roof 2 with a drive device 10 which is fastened below a part of the roof frame 4 at the car door side, i.e. in the region of the door transom of the car door. The drive device 10 is described in detail below and has the task of inducing all the pull means 7, which lead to the car roof 2, to synchronous longitudinal movements which produce a parallel lowering or raising of the car roof 2. Each of the pull means 7 is in that case guided at least partly in the flexible casing tube 8 tip to a support point 9 at the roof frame, which lies vertically above a fastening point of the pull means 7 at the lowerable car roof. The casing tube 8 of each Bowden pull preferably runs without interruption from the drive device 10 to the support point 9 at the roof frame 4, where it is fixed. However, in certain cases it can be advantageous to divide the casing tube 8 up into two or more sections 8.1 spaced apart in longitudinal direction. In the case of interrupted casing tubes 8.1 the ends, which are associated with the interruption, of the casing tubes are non-displaceably fixed to the elevator car, preferably by means of retaining members 12 at the roof frame 4. The associated pull means 7 always extends without interruption from the drive device 10 through the continuous or interrupted casing tube 8, 8.1 via the support point 9 at the roof frame to the fastening point, which is disposed vertically thereunder, at the car roof, wherein it can always run only rectilinearly between the ends, which are associated with an interruption, of the casing tubes 8.1.

Each of the Bowden pulls 6 can in that case—for the purpose of circumventing obstacles, for aesthetic reasons or so as not to form an obstruction for a maintenance person standing of the car roof—be arranged in innumerable variants and, as well, be bent in all desirable directions. In special cases, for example for a deflection with obligatory small deflection radius, it can be useful to use a deflecting roller instead of a deflection of the pull means by means of casing tube, as is illustrated by way of a deflecting roller 13.

In order to ensure that the car roof 2 during its lowering and raising movement does not come into contact with the usually scratch-sensitive car walls or with the keyboard of a control panel and, in addition, has sufficient horizontal stability as maintenance platform the car roof 2 is, as recognizable in FIG. 1, additionally connected with the roof frame 4 by means of a scissors mechanism 15. Use can be made of a form of embodiment of the scissors mechanism in which each scissors arm 15.1 is connected with the car roof or with the roof frame pivotably and non-displaceably in each instance by one of its ends and via a horizontally displaceable arm joint by the respective other end.

FIG. 1 shows another form of embodiment of a scissors mechanism which functions with non-displaceable arm joints 15.2. This solution requires, however, that all four scissors arms 15.1 going out from a central scissors joint 15.3 have to be telescopically extensible. The extension length of the scissors arms is limited by integrated abutments so that the scissors mechanism 15 forms a limitation of the depth of lowering of the car roof and stabilizes the car roof in all horizontal directions in the case of maximum lowering. Advantageously an elevator car is equipped with two or more such scissors mechanisms.

The scissors arms can also serve for guidance of a power cable ensuring the feed of electrical energy from the elevator car to the lowerable car roof so as to supply, for example, the lighting fixtures of the illuminated roof. Such a power cable can be fixed to, for example, each section of a scissors arm, wherein the power cable forms, in the region of the transition between two mutually displaceable sections, a hanging loop so as to bridge over the mutual displacement of the scissors arms.

An additional horizontal stabilization of the lowered car roof 2 is achieved by a pair of tension struts 17 which are arranged crosswise in a plane parallel to a car wall and are flexible in bending, but longitudinally stiff and which connect the car roof 2 with the roof frame 4. With maximum lowering of the car roof the tension struts 17 are tensioned, whereby the latter, in co-operation with the pull means 7 of the Bowden pulls carrying the car roof, suppress horizontal movements of the car roof 2 directed parallel to the said car wall.

FIG. 1 additionally discloses a relief device 18 which is based on the action of a biased spring and which bears a part of the weight of the car roof 2. Such a relief device has the advantage that the stroke force required for raising the car roof 2 is reduced, whereby the loading and thus the wear of the Bowden pulls 6 carrying the car roof as well as the actuation force, which has to be applied by a maintenance person, for the drive device 10 are less.

The illustrated relief device 18 comprises a cable drum 18.2 which is mounted on an elongated axle 18.1 and on which a relief cable 18.3 connected with the car roof 2 can be wound up or unwound in the manner of a thread. A helical spring 18.4 coupled by one end thereof with the cable drum 18.2 and by the other end thereof with a fixing part 18.5 is guided on the elongated axis. The helical spring 18.4 is biased as a torsion spring, wherein it exerts a torsional moment on the cable drum 18.2 so that there results in the relief cable 18.3 an upwardly directed tension force which counteracts the weight force of the car roof 2. Advantageously a respective such relief device 18 is mounted on each of two opposite sides of the elevator car 1.

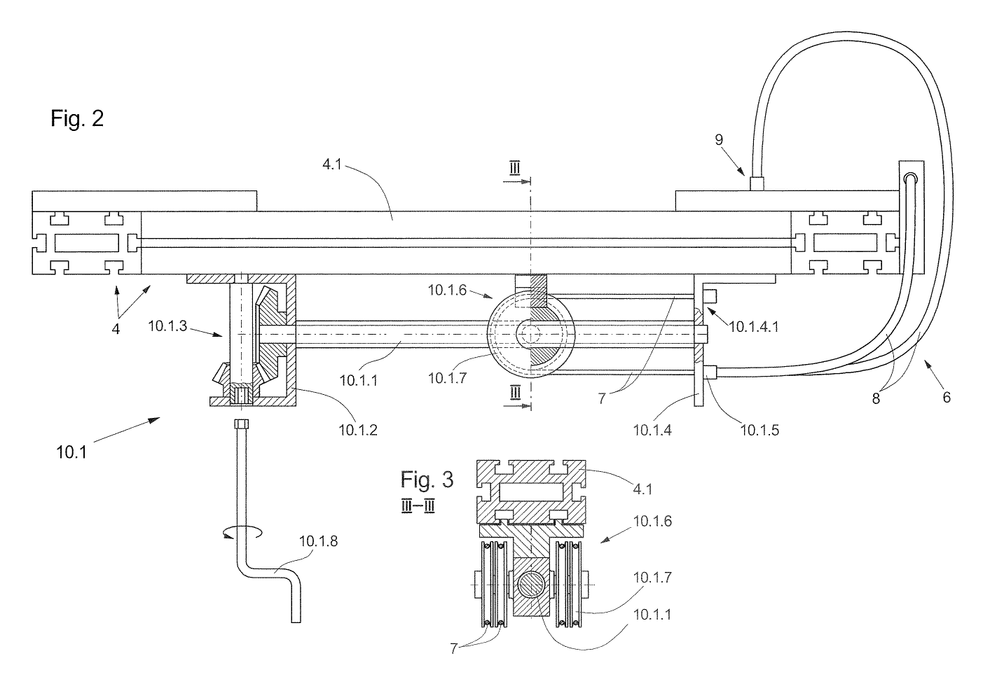

FIG. 2 shows a first variant 10.1 of the drive device, which is denoted in FIG. 1 by 10, for lowering and raising the car roof, which is not illustrated here. FIG. 3 illustrates a cross-section through the drive device 10.1 in the region of a linearly displaceable drive part 10.1.6 described in the following. The roof frame 4, which is preferably made of drawn aluminium profiles with integrated connecting and fastening grooves, can be recognized. The drive device 10.1 is so fastened at its roof frame element 4.1 at the car door side that, when the car door is installed, the device is arranged between a door transom of the car door and the passenger compartment.

The drive device 10.1 substantially comprises the following components:
a drive spindle 10.1.1;
a first support 10.1.2 with an integrated bevel gear 10.1.3 for driving the drive spindle 10.1.1;
a second support 10.1.4 with a bearing point for the drive spindle as well as with connecting points 10.1.5 for the casing tubes 8 of several Bowden pulls 6 leading to the lowerable car roof, and
the drive part 10.1.6, which is linearly displaceable with the help of the drive spindle 10.1.1 and which is guided at the roof frame element 4.1, with pull means deflecting rollers 10.1.7 for movement of the pull means of the Bowden pulls 6 leading to the car roof.

The task of the drive device according to FIGS. 2 and 3 is to transmit a synchronous longitudinal movement to the pull means of the Bowden pulls 6 carrying, or lowering and raising, the car roof. The pull means 7 are fixed by their ends at the drive side to fixing points 10.1.4.1 of the second support 10.1.4, extend from there to the respectively associated pull means deflecting rollers 10.1.7 of the linearly displaceable drive part 10.1.6, loop around this and run in an opposite direction back to the second support 10.1.4, where they enter the respectively associated flexible casing tubes 8, which are fixed to the second support, of the Bowden pulls 6, which guide the pull means to the support points 9, explained in connection with FIG. 1, at the car roof 4. The bevel gear 10.1.3 is driven and thus the drive spindle 10.1.1 set into rotation by a hand crank 10.1.8 or by means of an electrically operated torque motor—for example, by a drill—for lowering the car roof. Resulting from the rotation of the drive spindle is, for example, a linear displacement of the drive part 10.1.6 to the right so that the lower runs of the pull means 7 looped over the pull means deflecting rollers move to the right as a consequence of the weight force of the car roof acting thereon and—guided by the casing tubes—allow the car roof to silk. For raising the car roof the drive spindle 10.1.1 is rotated in opposite rotational direction so that the lower runs of the pull means 7 looped over the pull means deflecting rollers 10.1.7 are moved to the left.

It is readily recognizable that in the case of the drive arrangement illustrated in FIGS. 2 and 3 a displacement of the pull means 7 results which corresponds with twice the displacement travel of the linearly displaceable drive part 10.1.6. Thanks to this principle it is possible to achieve a sufficient stroke height of the lowerable car roof by one drive device, which can also be incorporated in narrow elevator cars parallel to the door transom of the car door. Quadruple displacement travels of the pull means could also be realized by additional non-displaceable and displaceable pull means deflecting rollers for the pull means 7 (not shown here).

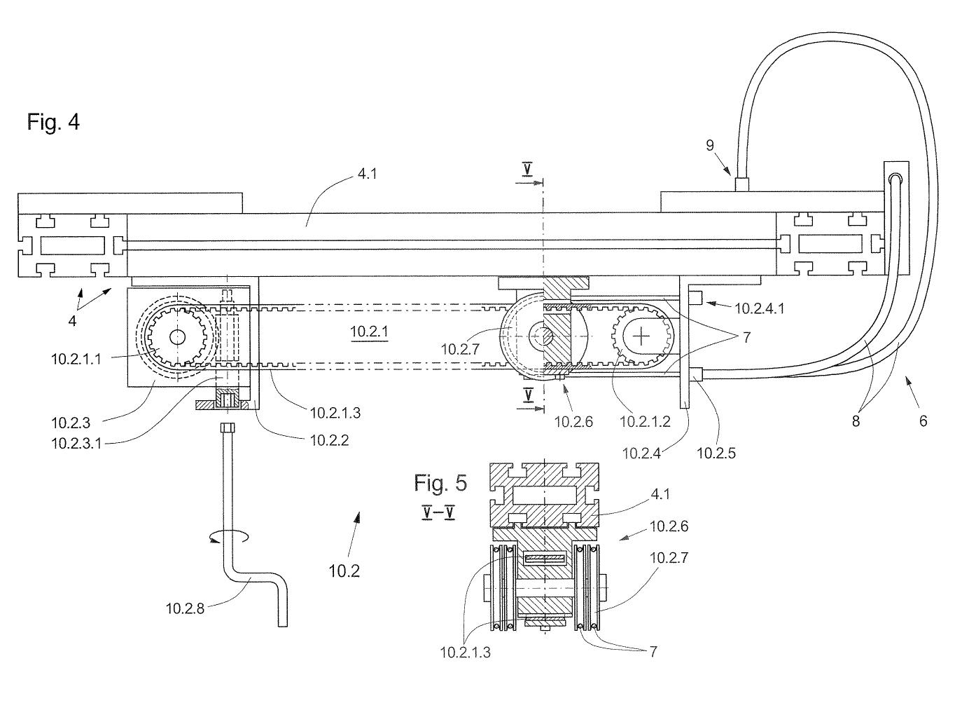

FIG. 4 shows a second variant 10.2 of the drive device denoted in FIG. 1 by 10. FIG. 5 illustrates a cross-section through this drive device 10.2 in the region of a linearly displaceable drive part 10.2.6 described in the following. The roof frame 4 with its roof frame element 4.1 which is at the car door side and to which the drive device 10.2 is fastened, so that this is arranged between a door transom of the car door and the passenger compartment when the car door is installed, can again be recognized.

The drive device 10.2 substantially comprises the following components:
a cogged belt drive 10.2.1 comprising a drive cogged belt pulley 10.2.1.1, a deflecting cogged belt pulley 10.2.1.2 and a cogged belt 10.2.1.3;
a first support 10.2.2 with an integrated worm gear 10.2.3 and a drive input shaft 10.2.3.1 for driving the cogged belt drive 10.2.1;
a second support 10.2.4 with a bearing point for the deflecting cogged belt pulley 10.2.1.2 as well as with connecting points 10.2.5 for the casing tubes 8 of several Bowden pulls 6 leading to the lowerable car roof; and
a drive part 10.2.6, which is linearly displaceable with the help of the cogged belt drive 10.2.1 and which is guided at the roof frame element 4.1, with pull means deflecting rollers 10.2.7 for movement of the pull means 7 of the Bowden pulls 6 leading to the car roof.

The task of the drive device according to FIGS. 4 and 5 is the same as that of the drive device according to FIGS. 2 and 3, i.e. it is to transmit a synchronous longitudinal movement to the pull means 7 of the Bowden pulls 6 carrying, or lowering and raising, the car roof. The pull means 7 are fixed by their ends at the drive side to fixing points 10.2.4.1 of the second support 10.2.4, extend from there to the respectively associated pull means deflecting rollers 10.2.7 of the linearly displaceable drive part 10.2.6, loop around these and extend in opposite direction back to the second support 10.2.4, where they enter the respectively associated flexible casing tubes 8, which are fixed to the second support, of the Bowden pulls 6, which guide the pull means to the support points 9—explained in conjunction with FIG. 1—at the roof frame 4. The worm gear 10.2.3 is driven by way of the input drive shaft 10.2.3.1 and thus the cogged belt drive 10.2.1 set into motion by a hand crank 10.2.8 or by means of an electrically operated torque motor—for example by a drill—for lowering the car roof. A linear displacement of the drive part 10.2.6 coupled with the lower run of the cogged belt drive to, for example, the right results from the movement of the cogged belt 10.2.1 so that the lower runs of the pull means 7 looped over the pull means deflecting rollers 10.2.7 move to the right as a consequence of the weight force of the car roof acting thereon and—guided by the casing tubes—allow the car roof to sink. For raising the car roof the cogged belt drive 10.2.1 is moved in opposite rotational direction so that the lower runs of the pull means 7 looped over the pull means deflecting rollers 10.2.7 are moved to the left. A displacement of the pull means 7 and thus a stroke travel of the car roof corresponding with twice the displacement travel of the linearly displaceable drive part 10.2.6 also result with this variant of the drive device.

A chain drive can also be used instead of the cogged belt drive 10.2.1.

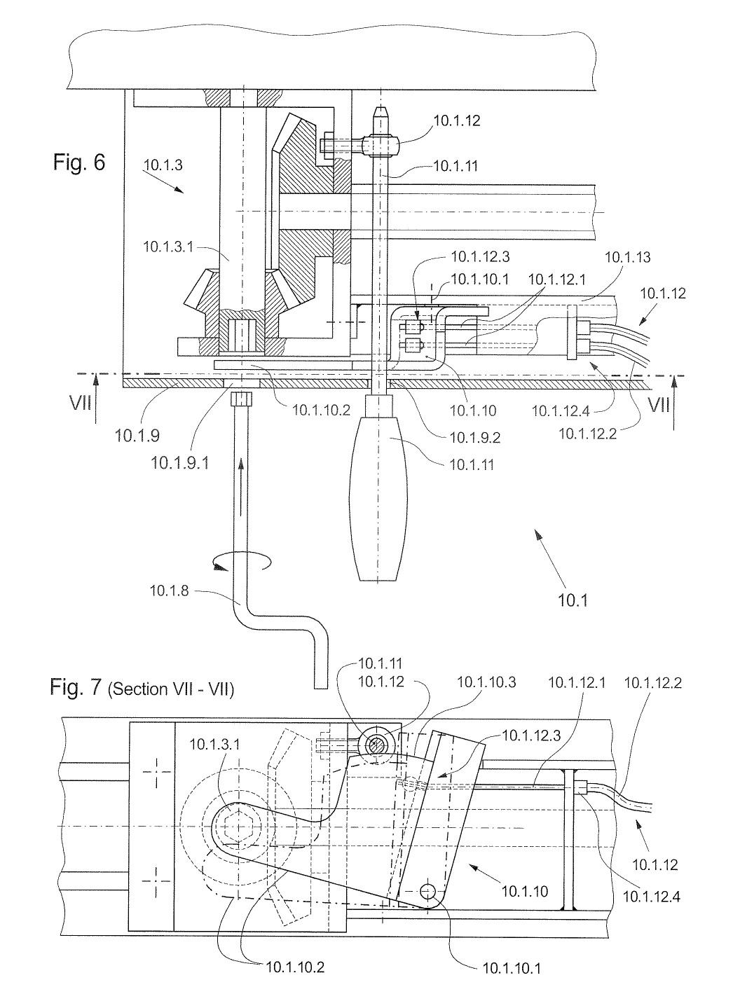

FIG. 6 shows details of the drive device 10.1, particularly safety devices against unauthorized actuation of the drive device and against unintended sinking of the car roof. FIG. 7 illustrates a section VII-VII, which is seen from below, through the part of the drive device with the safety devices, wherein the cover 10.1.9 is regarded as not present.

The bevel gear 10.1.3 for manually actuated driving of the drive spindle 10.1.1 of the drive device, which is described by FIGS. 2 and 3, for lowering and raising the car roof can be recognized in FIG. 6. The drive of the bevel gear preferably takes place with the help of the hand crank 10.1.8 which is coupled with the input drive shaft 10.1.3.1 of the bevel gear 10.1.3 by means of a coupling device. As an alternative, use can be made of a manually guided, electrically operated torque motor. The hand crank or torque motor is handled, during lowering or raising of the car roof, by a maintenance person standing on a floor, wherein the shaft door and also the car door are opened.

The drive device 10.1 arranged in the region of the door transom of the car door is concealed by a cover 10.1.9 having a first opening 10.1.9.1 through which the hand crank 10.1.8 can be coupled with the drive input shaft 10.1.3.1. In order to hinder unauthorized actuation of the drive device this is equipped with a turntable 10.1.10 which is arranged between the cover 10.1.9 and the drive input shaft 10.1.3.1 and which is pivotably fastened to a U-shaped carrier section 10.1.13 by way of a rotational axle 10.1.10.1. In its self- centered basic setting the turntable blocks, by its blocking blade 10.1.10.2, introduction of the coupling member of the hand crank 10.1.8. In order for the maintenance person to be able to couple the hand crank with the drive input shaft 10.1.3.1 that person must introduce a screwdriver-like tool 10.1.11 vertically into a slot-shaped second opening 10.1.9.2 and into the bore of a universal joint head 10.1.12 arranged vertically above the opening. Through pivoting of the tool in the direction predetermined by the slot-shaped second opening the shank of the tool 10.1.11 acts against an actuating runner 10.1.10.3 at the turntable 10.1.10, whereby the turntable is pivoted about its rotational axis 10.1.10.1 and its blocking blade 10.1.10.2 frees access to the drive input shaft 10.1.3.1. This setting of the turntable is illustrated in FIG. 7 by dot-dashed lines. The hand crank introduced into the coupling member of the drive input shaft now prevents the turntable from being able to pivot back into its self-centered basic setting.

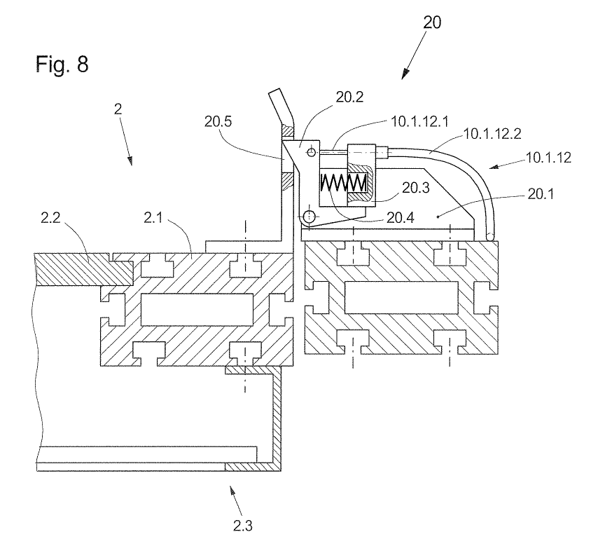

The movement of the turntable 10.1.10 produced for coupling the hand crank 10.1.8 is used in order to actuate, by way of unlocking Bowden pulls 10.1.12, the locking pawls of at least two locking devices preventing unintended sinking of the car roof. Such a locking device is illustrated in FIG. 8 and described in the following section. In FIGS. 6 and 7 the points at which the first ends of the pull means 10.1.12.1 of the unlocking Bowden pulls 10.1.12 are coupled to the turntable 10.1.10 are marked by 10.1.12.3 and those points at which the first ends of the associated flexible casing tubes 10.1.12.2 of the unlocking Bowden pulls 10.1.12 are fixed to the drive device are marked by 10.1.12.4.

It will be obvious that the afore-described safety devices are also usable with a drive device with cogged belt drive or chain drive.

FIG. 8 shows one of the locking devices 20, which prevent unintended dropping down of the car roof 2, explained in the foregoing. A cross-section through a roof frame element 10.2 of the roof frame 4 and an adjacent edge region of the car roof 2 with a roof frame profile 2.1, a roof plate 2.2 and a lighting cover 2.3 is illustrated. Fixed on the roof frame element 4.2 is the locking device 20 which comprises a pawl support 20.1, a locking pawl 20.2 pivotably mounted on the pawl support, and a holder 20.3, which is connected with the pawl support, for a pawl return spring 20.4 as well as for fastening the casing tube 10.1.12.2 of an unlocking Bowden pull 10.1.12 described in connection with FIGS. 6 and 7. A pawl abutment 20.5 in which the locking pawl 20.2 engages in its spring-centered rest setting, whereby any unintended sinking of the car roof 2 is prevented, is fixed on the roof frame profile member 2.1.

As already explained in connection with the safety devices, which were illustrated in FIGS. 6 and 7, at the drive device 10.1 a turntable 10.1.10 is displaced prior to actuation of the drive device, wherein the movement of the turntable is used for actuation of at least two locking Bowden pulls 10.1.12. These locking Bowden pulls lead from the drive device 10.1 to at least two locking devices 20 of the afore-described kind, wherein the pull means 10.1.12.1 of the locking Bowden pulls 10.1.12 draw the locking pawls 20.2 out of the region of the pawl abutments 20.5 against the force of the pawl return springs 20.4, so that the drive device 10.1 can lower the car roof 2 by way of the Bowden pulls carrying these. As soon as the car roof 2 after use thereof as a maintenance platform is raised back into its normal position and the hand crank 10.1.8 frees the turntable 10.1.10 in the drive device 10.1 the locking pawls through the force of the pawl return springs 20.4 detent again in the pawl abutments and again secure the car roof 2 against sinking.

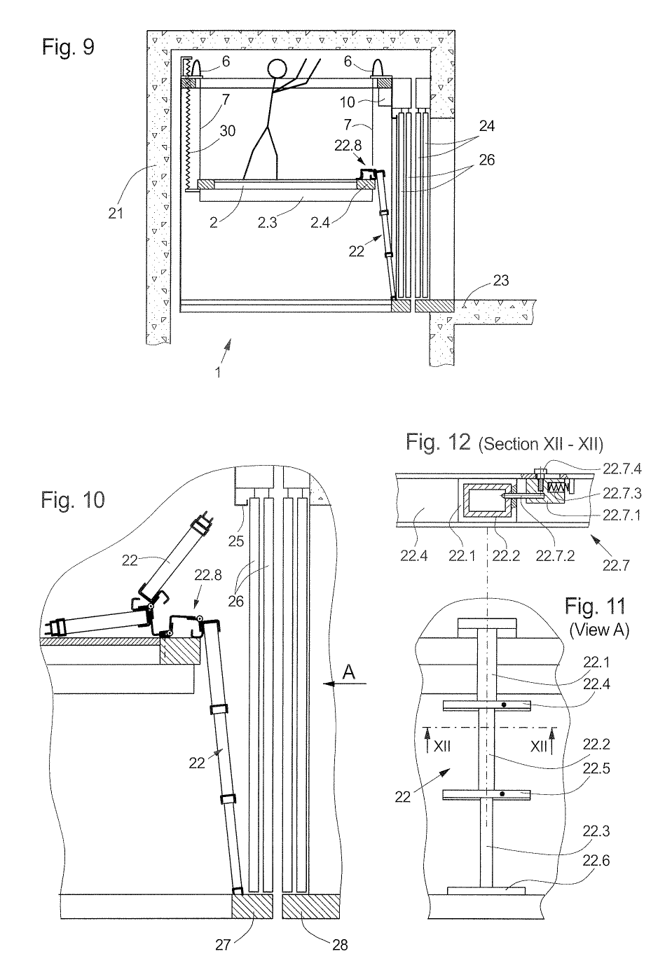

FIG. 9 schematically shows an elevator car 1 according to the invention which is movable in an elevator shaft 21 and which is positioned at a floor 23 with a shaft door 24. A car door 26 and the shaft door 24 are opened. A car roof 2 lowered at the pull means 7 of the Bowden pulls 6 and serving as a maintenance platform can be recognized in the elevator car 1. In addition, a climbing ladder 22 which assists a maintenance person in climbing from the floor 23 onto the lowered car roof 2 is illustrated. The climbing ladder 22 is telescopically extensible and during normal elevator operation is stowed in pushed-together, approximately horizontal state on the car roof 2, wherein it is connected with the roof frame profile member 2.4 at the car door side by way of a joint combination 22.8. When the car roof 2 is lowered the climbing ladder 22 can be pivoted by a maintenance person, who is standing on the floor, through an angle of approximately 270° from its horizontal position on the car roof into a virtually vertical climbing position in the region of the opened elevator door 24 so that the maintenance person can comfortably climb onto the car roof 2 lowered as maintenance platform. The foot of the climbing ladder 22 is in that case supported in a position on the car floor which makes it possible to close the elevator doors 24, 26 and to move the elevator car 1 at inspection speed to the inspection locations in the elevator shaft.

FIG. 10 shows the pivot process of the climbing ladder 22 in detail. Thanks to the joint combination 22.8, which comprises two joints, and the collapsible form of embodiment of the climbing ladder this can be pivoted below the door transom 25 of the open car door 26 when the car roof 2 is lowered and be brought into its almost vertical climbing position. The rectangular tubes 22.1, 22.2, 22.3, which form three sections, of the climbing ladder 22 are subsequently pulled out and mutually locked so that a rung 22.6 of the lower rectangular tube 22.3 reaches the car door threshold 27 or the shaft door threshold 28 and can be supported on one of the thresholds.

A so-called helix cable ensuring the feed of electrical energy from the elevator car 1 to the lowerable car roof 2 so as to supply, for example, the lighting fixtures of the car roof 2.3 is illustrated by reference numeral 30 in FIG. 9. This form of current supply is an economic, space-saving and easily installable alternative to a power cable, which is led through the scissors mechanism according to FIG. 1, or to separable plug connections.

FIG. 9 additionally allows recognition of the position of the afore-described drive device 10 in the region of the door transom 25 of the car door 26, wherein only a schematic cross-section of the drive device is indicated.

FIG. 11 shows a view “A” of the extensible climbing ladder 22 illustrated in FIG. 10, i.e. a view from the shaft door side onto the extended climbing ladder standing in climbing position. It can be seen that the climbing ladder 22 has a single central ladder post which comprises three sections formed by three rectangular tubes 22.1, 22.2., 22.3, wherein the lower rectangular tube 22.3 of the lower section plugs into and is telescopically guided in the middle rectangular tube 22.2 of the middle section and the middle rectangular tube 22.2 of the middle section is plugged into and telescopically guided in the upper rectangular tube 22.1 of the upper section. A respective rung 22.4, 22.5, 22.6 serving as a step rung of the climbing ladder is rigidly fastened to the respective lower end of each rectangular tube. The climbing ladder 22 is constructed to be extensible so as to enable it to be pivoted below the door transom 25 (FIG. 10) of the car door when the car roof 2 is lowered. The ladder can obviously also comprise a different number of sections.

FIG. 12 shows a section XII-XII through the climbing ladder 22 according to FIG. 11. There are illustrated the outer upper rectangular tube 22.1 of the upper section with the rung 22.4 fastened thereto, the middle rectangular tube 22.2 guided in the rectangular tube and belonging to the middle section, and a ladder post locking device 22.7 which mutually locks the two rectangular tubes 22.1, 22.2 in a defined extended state. The ladder post locking device 22.7 comprises a locking member 22.7.1, which is displaceably mounted in the associated ladder rung 22.4 and in which is fixed a locking pin 22.7.2 which, in the extended state of the two participating rectangular tubes, detents in respectively corresponding bores of the two rectangular tubes through the force of an engagement spring 22.7.3 and mutually locks these tribes. For pushing together the two rectangular tubes 22.1, 22.2 belonging to this locking device the locking member 22.7.1 with the locking pins 22.7.2 can be retracted by means of an unlocking head 22.7.4 against the force of the engagement spring 22.7.3 to such an extent that the locking pin comes out of the bore of the inner rectangular tube, whereby the two rectangular tubes are again mutually displaceable. The same ladder post locking device is also present at the connecting point between the middle rectangular tube 22.2 and the lower rectangular tube 22.3 of the climbing ladder 22.

In accordance with the provisions of the patent statutes, the present invention has been described in what is considered to represent its preferred embodiment. However, it should be noted that the invention can be practiced otherwise than as specifically illustrated and described without departing from its spirit or scope.

1-11. (canceled)

12. A drive system for providing a parallel vertical displacement of a car roof of an elevator car, comprising:
a roof frame relative to which the car roof is to be vertically displaced;
a plurality of Bowden pulls each comprising at least one casing tube and a pull means guided therein;
a fixed support comprising connecting points to which first end sections of the casing tubes of said Bowden pulls are attached;
a drive part which is linearly displaceable relative to said fixed support by means of a drive device; and
wherein second end sections of said casing tubes are fixed to said roof frame, second end sections of said pull means are attached to attachment points on said car roof, the attachment points being spaced distant from each other, and first end sections of the pull means cooperate with said drive part whereby a displacement of said drive part causes synchronous displacement of all of said pull means and subsequently a parallel vertical displacement of the car roof.

13. The drive system according to claim 12 wherein said pull means cooperate with said drive part whereby the resulting displacement of said pull means and thus the resulting vertical displacement of the car roof is in a range of double to four times the displacement of said drive part.

14. The drive system according to claim 12 wherein said drive part is displaced by means of a drive spindle which is set into rotation by a hand crank or an electrically operated motor.
